(19) United States
(12) Patent Application Publication
(10) Pub. No.: US 2023/0054170 A1
(43) Pub. Date: Feb. 23, 2023

(54) SATELLITE

(71) Applicant: SOLETOP CO., LTD., Daejeon (KR)

(72) Inventors: Yeongbo Sagong, Daejeon (KR); Sumin Jang, Daejeon (KR)

(21) Appl. No.: 17/412,616

(22) Filed: Aug. 26, 2021

(30) Foreign Application Priority Data
Aug. 23, 2021 (KR) 10-2021-0110975

(51) Int. Cl. G06T 7/30; H04B 7/185

(52) U.S. Cl. CPC G06T 7/30; H04B 7/18573; G06T 2207/10032

(57) ABSTRACT

An artificial satellite 100 for transmitting an image to the at least one ground station 120 is provided. The artificial satellite operates in a space environment, displays the content 410 received from at least one ground station 120, captures the content 410 with the background 420 in outer space, and captures the content 410.

### CROSS-REFERENCE TO RELATED APPLICATION

This application claims priority to and the benefit of Korean Patent Application No. 10-2021-0110975, filed on Aug. 23, 2021, in the Korean Intellectual Property Office, the entire content of which are incorporated herein by reference.

### FIELD OF THE INVENTION

The present invention relates to a method of photographing using a satellite 100 operated in a space environment and a method of operating the ground station 120, and more particularly, receiving from the ground station 120 using the satellite 100 operated in a space environment. It relates to a method and apparatus for photographing one content 410.

### DESCRIPTION OF THE RELATED ART

If the existing satellite demand was the public market, the demand for low-cost and high-efficiency small satellites is steadily increasing as it has recently expanded to the private market. Among the satellite industries that are expected to grow continuously, the small satellite industry is showing rapid growth recently. A small satellite is a satellite weighing less than 100 kg. A typical example of a small satellite is Cubesat.

In general, Cubesat is a cube-shaped miniature satellite with sizes of 1 U, 2 U, 3 U, and 6 U that can be stacked based on 1 U (10 cm (width)*10 cm (length)*10 cm (height)). It can be assembled and launched at a lower cost than commercial satellites, and it can be used for various purposes such as space science research such as biological experiments and space particle detection, preliminary verification of technology for medium and large satellites, and space exploration.

### SUMMARY OF THE INVENTION

Example embodiments provide satellite 100 for transmitting an image to the at least one ground station 120, it operates in a space environment, displays the content 410 received from at least one ground station 120, captures the content 410 with the background 420 in outer space, and captures the content 410 and comprises;

a satellite body 210 for receiving a mission including the content 410 from the at least one ground station 120,

a display panel 230 for displaying the content 410 received from the at least one ground station 120,

an image sensor 220 for photographing the content 410 displayed on the display panel 230 with the outer space as a background 420, and

a direction sensor capable of determining a photographing direction of the image sensor 220,

wherein the mission further includes a request for shooting at least one of an image, video, or text desired by the customer with information about a shooting time or shooting location generated based on the customer's order information, and a real outer space as a background 420,

when the shooting direction of the image sensor 220 matches the mission with respect to the direction sensor, the satellite body 210 determines a position between the display panel 230 and the image sensor 220 and, determine a photographing area of the image sensor 220,

wherein the image sensor 220 is a satellite 100, characterized in that for shooting the content 410 in real outer space as a background 420 at a shooting time or shooting location included in the mission.

### BRIEF DESCRIPTION OF DRAWINGS

FIG. 1 is a diagram illustrating a satellite system according to an embodiment.

FIG. 2 is a diagram illustrating a configuration of an artificial satellite according to an embodiment.

FIG. 3 is a diagram illustrating a flowchart of a photographing method using an artificial satellite according to an embodiment.

FIG. 4 is a diagram illustrating a captured image according to an embodiment.

FIG. 5 is a diagram illustrating a method of determining a photographing area according to an exemplary embodiment.

FIG. 6 is a flowchart illustrating a method of operating a ground station according to an embodiment.

FIG. 7 is a diagram illustrating a photographed image including a certificate according to an embodiment.

### DETAILED DESCRIPTION OF THE INVENTION

Specific structural or functional descriptions of the embodiments according to the concept of the present invention disclosed herein are only exemplified for the purpose of explaining the embodiments according to the concept of the present invention, and the embodiment according to the concept of the present invention These may be embodied in various forms and are not limited to the embodiments described herein.

Since the embodiments according to the concept of the present invention may have various changes and may have various forms, the embodiments will be illustrated in the drawings and described in detail herein. However, this is not intended to limit the embodiments according to the concept of the present invention to specific disclosed forms, and includes changes, equivalents, or substitutes included in the spirit and scope of the present invention.

Terms such as first or second may be used to describe various elements, but the elements should not be limited by the terms. The above terms are used only for the purpose of distinguishing one element from other elements, for example, without departing from the scope of rights according to the concept of the present invention, a first element may be named as a second element, Similarly, the second component may also be referred to as the first component.

When a component is referred to as being “connected” or “connected” to another component, it may be directly connected or connected to the other component, but it is understood that other components may exist in between. it should be. On the other hand, when it is mentioned that a certain element is “directly connected” or “directly connected” to another element, it should be understood that there is no other element in the middle. Expressions describing the relationship between elements, for example, “between” and “between” or “directly adjacent to”, etc., should be interpreted similarly.

The terminology used herein is used only to describe specific embodiments, and is not intended to limit the present invention. The singular expression includes the plural expression unless the context clearly dictates otherwise. In the present specification, terms such as “comprise” or “have” are intended to designate that the described feature, number, step, operation, component, part, or combination thereof exists, and includes one or more other features or numbers, It should be understood that the possibility of the presence or addition of steps, operations, components, parts or combinations thereof is not precluded in advance.

Unless defined otherwise, all terms used herein, including technical or scientific terms, have the same meaning as commonly understood by one of ordinary skill in the art to which this invention belongs. Terms such as those defined in a commonly used dictionary should be interpreted as having a meaning consistent with the meaning in the context of the related art, and should not be interpreted in an ideal or excessively formal meaning unless explicitly defined in the present specification. does not

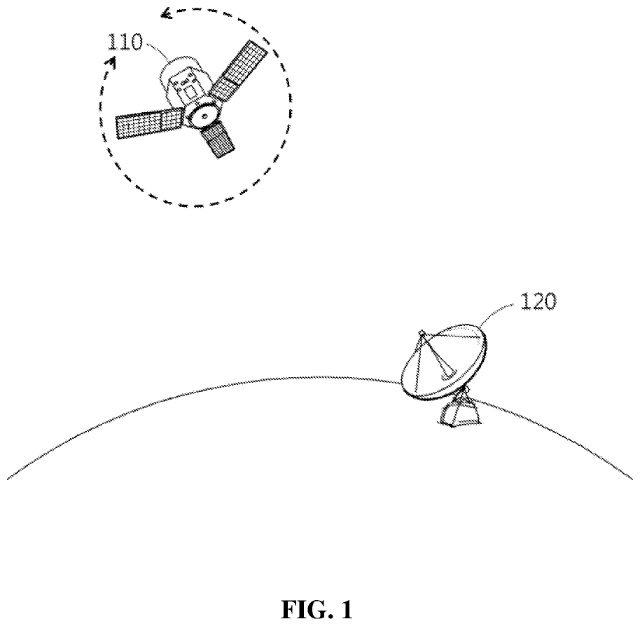

FIG. 1 is a diagram illustrating an artificial satellite system according to an embodiment.

Referring to FIG. 1, an artificial satellite system according to an embodiment may include an artificial satellite 110 and a ground station 120.

The artificial satellite 110 is an artificial object that is launched out of the atmosphere using a rocket and flies like a satellite in a circular or elliptical orbit mainly around the earth, and may be an object artificially made to rotate around a planet. The artificial satellite 110 may perform tasks such as communication with the ground station 120, earth observation, ocean observation, meteorological observation, navigation and positioning, and space science research. A ground station 120 may be installed on the earth to control the artificial satellite 110 launched into space.

The ground station 120 is a base station in charge of the entirety of the ground part, such as an operating organization and system that performs all processes occurring on the ground among the satellite 110 missions. It is possible to adjust the position and posture of the satellite 110 so that a schedule can be commanded, and to receive and process the data observed by the satellite 110 with an antenna, and then serve, research, use, etc. can be performed.

The artificial satellite 110 may be a small satellite or a small satellite with a predetermined weight (e.g., 100 kg in weight). For example, the satellite 110 may be a CubeSat. In general, Cubesat is a cube-shaped miniature satellite with sizes of 1 U, 2 U, 3 U, and 6 U that can be stacked based on 1 U (10 cm (width)*10 cm (length)*10 cm (height)). It can be assembled and launched at a lower cost than commercial satellites.

The use purpose of the artificial satellite 110 may be predetermined. The purpose of using the artificial satellite 110 may be called a mission. The mission may refer to a planned mission performed by the artificial satellite 110 in orbit. For example, the mission may include missions such as communication, earth observation, ocean observation, meteorological observation, navigation and positioning, space science research, and the like, but is not limited to the described embodiment. The satellite 110 may receive a mission from the ground station 120, perform a mission according to the mission, and transmit the result to the ground station 120.

The satellite 110 may receive a mission from the ground station 120 to shoot an image, video, or text desired by a customer against the background of real outer space, and to transmit the captured image to the ground station 120. More specifically, a shooting plan for a shooting time and location preferred by the customer may be determined, and shooting may be performed based on the determined shooting plan. In addition, the mission may include a photographing direction desired by the customer. For example, it may include a photographing direction in which the earth occupies a ratio in an area corresponding to the background, a photographing direction including a specific planet in the background, a photographing direction including a specific satellite including the moon, and the like. The direction in which the earth occupies and the direction in which the planet or satellite is included is the same as the direction in which the image sensor of the satellite is photographed from the direction sensor provided in the satellite and the planet and satellite information that can be collected online can determine whether or not Here, the direction sensor may include at least one of a gyro sensor and a geomagnetic sensor, and a photographing direction of the image sensor provided in the artificial satellite may be calculated from the gyro sensor and/or the geomagnetic sensor.

Referring to FIG. 1, depending on the satellite, the photographing direction of the image sensor may not be constant and may be rotated. In the present invention, the artificial satellite can determine the direction of the artificial satellite by having the direction sensor, and photographing included in the mission desired by the customer. There is an advantage in that it is possible to provide the content desired by the customer by determining whether it is a direction or not.

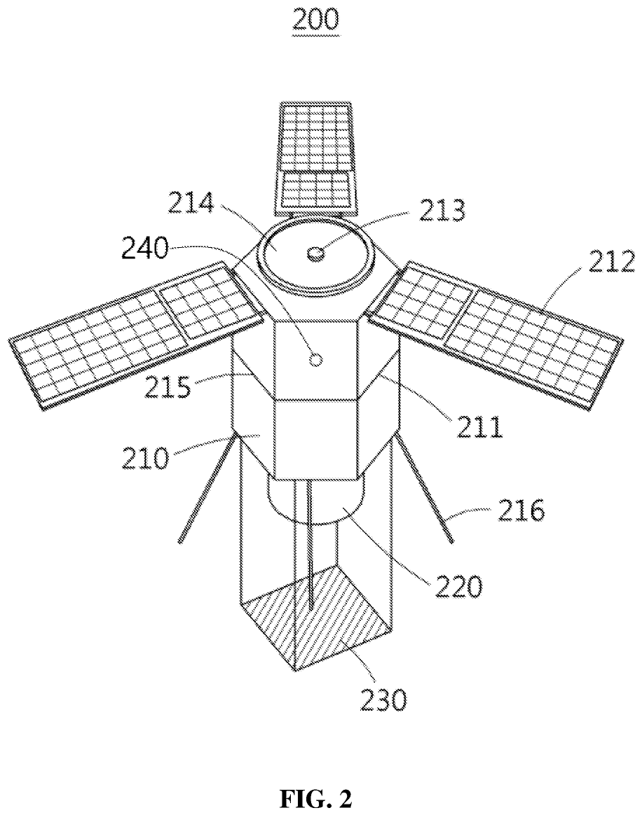

Although only one ground station is illustrated in the drawings for convenience of explanation, the satellite 110 may communicate with at least one ground station. Hereinafter, a photographing method using an artificial satellite operated in a space environment will be described in detail with reference to FIGS. 2 to 7.

Although not shown in the drawings, the satellite system may further include a service server providing interfacing with a customer. The service server may receive order information from customers in various ways such as web, app, and e-mail. In addition, the service server may provide the captured image according to the order information to the customer in various ways, such as a web, an app, an e-mail.

In a service scenario in which the ground station 120 is directly operated, the service server may be included in the ground station 120 or may be implemented to interwork with the ground station 120. Alternatively, when using a ground station operated by another service company, the service server may be implemented to communicate with the corresponding ground station.

FIG. 2 is a diagram illustrating a configuration of an artificial satellite according to an embodiment.

Referring to FIG. 2, an artificial satellite 200 according to an exemplary embodiment includes a satellite body 210, a display panel 230, and an image sensor 220.

The satellite body 210 may communicate with at least one ground station. For example, a mission including content may be received from at least one ground station, and a captured image captured by the image sensor 220 may be transmitted to the at least one ground station.

The satellite body 210 may include a processor 211, a memory, a battery 212, a sensor unit 214, a navigation unit 213, a driving unit 215, and a communication unit 216. The sensor unit 214 may include a solar sensor, and the navigation unit 213 may include a GPS. The state and location information of the satellite may be acquired using the sensor unit 214 and the navigation unit 213. The driving unit 215 may be, for example, a thruster, and the posture or speed may be changed using the driving unit 215.

The communication unit 216 may be connected to the sensor unit 214, the navigation unit 213, the processor 211, and the memory to transmit/receive data to and from the ground station. The communication unit 216 may be connected to another external device to transmit/receive data. Hereinafter, the expression “transmitting and receiving “A” may indicate transmission and reception of “information or data indicating A”.

The communication unit 216 may be implemented as circuitry in the satellite 200. For example, the communication unit 216 may include an internal bus and an external bus. As another example, the communication unit 216 may be an element connecting the satellite 200 and an external device. The communication unit 216 may be an interface. The communication unit 216 may receive data from an external device and transmit the data to the processor 211 and the memory.

The processor 211 may process the data received by the communication unit 216 and data stored in the memory. The “processor 211” may be a data processing device implemented in hardware having circuitry having a physical structure for executing desired operations. For example, desired operations may include code or instructions included in a program. For example, a data processing device implemented as hardware includes a microprocessor, a central processing unit, a processor core, a multi-core processor, and a multiprocessor, an Application-Specific Integrated Circuit (ASIC), and a Field Programmable Gate Array (FPGA).

The processor 211 may execute computer readable code (e.g., software) stored in a memory (eg, memory) and instructions issued by the processor 211.

The memory stores data received by the communication unit 216 and data processed by the processor 211. For example, the memory may store a program. The stored program may be a set of syntaxes coded to assist the user in walking and executable by the processor 211.

According to one aspect, memory may include one or more of volatile memory, non-volatile memory and random access memory (RAM), flash memory, hard disk drive, and optical disk drive.

The memory may store a set of instructions (e.g., software) for operating the walking assistance device. An instruction set for operating the satellite 200 may be executed by the processor 211.

The image sensor 220 may photograph the content displayed on the display panel 230 with the background of outer space. The image sensor 220 may be, for example, a camera.

The display panel 230 may display content received from the ground station. The display panel 230 is a liquid crystal display (LCD), a thin film transistor-liquid crystal display (TFT-LCD), a liquid emitting diode (LED) display, an organic LED (OLED) display, an active matrix OLED (AMOLED) display, or a flexible display. It may be implemented as a (flexible) panel, but is not limited thereto. Since the display panel 230 operates in a space environment, the display panel 230 may be a panel with enhanced heat resistance. Alternatively, the display panel 230 may be implemented as a transparent display panel.

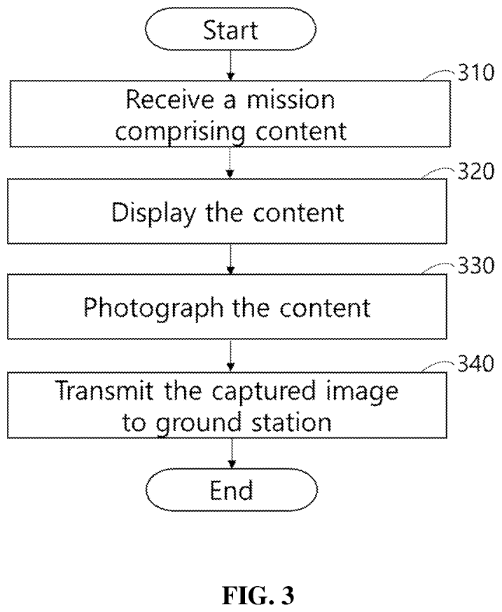

FIG. 3 is a diagram illustrating a flowchart of a photographing method using an artificial satellite according to an exemplary embodiment.

Referring to FIG. 3, steps 310 to 340 according to an embodiment are performed by the satellite 200 described above with reference to FIG. 2. The satellite 200 may be implemented by one or more hardware modules, one or more software modules, or various combinations thereof. The artificial satellite 200 may be operated in a space environment.

In step 310, the satellite 200 receives a mission comprising content from at least one ground station. The mission may include content and preference information to be displayed on the panel. The preference information is information generated based on the customer's order information, and may include information about a shooting time or a shooting location. For example, the mission may be a mission of capturing an image, video, or text desired by the customer at a time and place desired by the customer and transmitting the captured image to at least one ground station against the background of real outer space.

The satellite 200 may receive content not only from a ground station, but also from other satellites. For example, the satellite 200 may receive a mission including content from other existing satellites other than the ground station. Other satellites may be operated by other service companies, and the corresponding satellites may communicate with a separate ground station operated by other service companies. As will be described in detail below, the service server according to an embodiment may receive customer order information through a network and transmit a mission based on the order information to a ground station of another service company.

In step 320, the satellite 200 displays the content on the display panel. The content may include at least one of text, a still image, and a video. The position and size at which the content will be displayed may be predetermined. For example, the text may be predetermined to be positioned at the exact center of the display panel. Alternatively, the still image may be predetermined to be displayed in full screen on the display panel.

The satellite 200 may adjust and display the content based on the background. Depending on the background, the color, brightness, etc. of the content can be adjusted and displayed differently. Alternatively, a predetermined visual effect may be added according to the background. For example, content can be adjusted and displayed differently when the earth is the background and when a space other than the earth is the background.

In step 330, the satellite 200 uses the image sensor to photograph the content displayed on the display panel in the background of outer space. Based on the preference information, the satellite 200 may capture a still image, a moving picture, or a text desired by the customer in the actual outer space at a time and place desired by the customer based on the preference information. The captured image, which is the captured result, may include at least one of a still image and a moving image.

The aperture value, shutter speed, sensitivity, etc. of the image sensor may be determined in consideration of the rotation speed of the satellite 200 and the brightness of light. For example, when the satellite 200 rotates rapidly, the shutter speed may be increased to prevent shaking of the captured image. By using the image sensor, you can shoot with special effects by applying a zero-gravity environment. According to an embodiment, a watermark may be inserted into an image using a visual effect that can be photographed only in a space environment.

In step 340, the satellite 200 transmits the captured image to at least one ground station. There may be one or more captured images. The artificial satellite 200 may transmit an image captured by other satellites as well as a ground station. For example, the artificial satellite 200 may transmit an image captured by other satellites operated by other service companies, rather than the ground station. In this case, the captured image may be transmitted to the service server through satellites and ground stations of other service companies. The service server may deliver the received captured image to the customer.

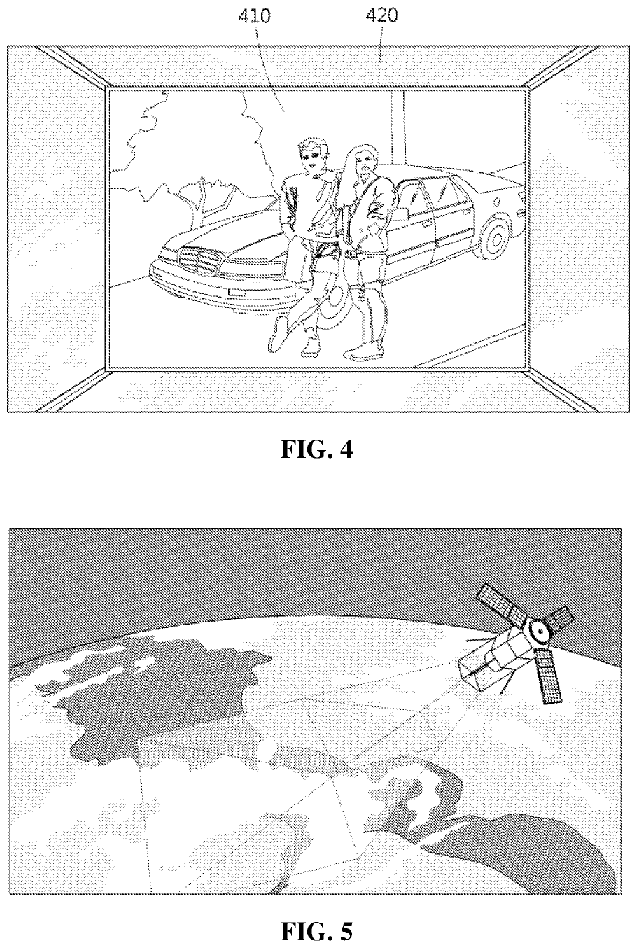

FIG. 4 is a diagram illustrating a captured image according to an exemplary embodiment.

Referring to FIG. 4, a captured image according to an embodiment may include content 410 and a background 420.

The content 410 may be displayed on the display panel, and the background 420 may be determined based on preference information. The preference information may include a time and place desired by the customer, and the background 420 of the captured image may be determined based on this.

The preference information may include customer needs. For example, the preference information may include various needs, such as wanting to set the background of a typhoon, wanting to set the boundary between the earth and space, or wanting to set the background of a specific constellation. Alternatively, the preference information may include information requesting photographing to change the viewing angle in outer space from the background of the earth to the background of the moon.

The content 410 may include at least one of text, a still image, and a moving image, and the captured image may include at least one of a still image and a moving image. For example, when the content 410 is a still image, the captured image may also be a still image. Alternatively, when the content 410 is a moving image, the captured image may also be a moving image. When the captured image is a moving picture, the background 420 may also be changed.

FIG. 5 is a diagram illustrating a method of determining a photographing area according to an exemplary embodiment.

Referring to FIG. 5, an artificial satellite according to an embodiment has a limited time for communicating with a ground station. For example, in the case of a satellite that orbits the earth once in about 98 minutes, it can orbit the earth 14 and a half times in a day. In this case, the ground station can communicate with the satellite 3 to 4 times a day, it can only be done in 10 minutes. If there is a ground station in the North Pole or Antarctic region that passes each time it orbits the Earth, it could be possible to communicate up to about 90% of the number of times the satellite orbits the Earth in a day, that is, more than 10 times.

In order to communicate with the ground station, the artificial satellite may determine whether the current location is an area capable of communicating with at least one ground station, and, if the area is in the communication area, may acquire information on a communication resource. The artificial satellite may receive a mission from at least one ground station by utilizing a communicable resource, and may transmit a photographed image to the at least one ground station.

Although not shown in the drawings, the satellite according to an embodiment may change the photographing area. For example, the size and position of the display panel may be changed in the captured image.

Within a predetermined range, the satellite may determine a position between the display panel and the image sensor. For example, the display panel may be located closer to or farther from the image sensor. When the display panel is positioned close to the image sensor to photograph, the ratio of the background in the photographed image may be reduced. Conversely, when the display panel is positioned far away from the image sensor to photograph, the ratio of the background to the photographed image may increase. A position between the display panel of the satellite and the image sensor may be predetermined.

The satellite may determine the imaging area of the image sensor. For example, the display panel may be positioned at the exact center of the captured image. Alternatively, the display panel may be positioned at the edge of the captured image.

The operation of determining the photographing area may be performed through manipulation of an image sensor. For example, a position between the display panel and the image sensor may be determined by adjusting the magnification of the camera. Also, the photographing area may be determined by adjusting the angle of the camera.

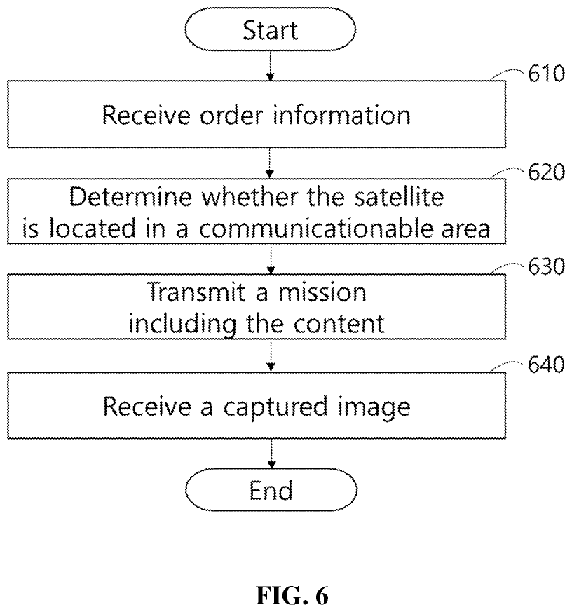

FIG. 6 is a flowchart illustrating a method of operating a ground station according to an embodiment.

Referring to FIG. 6, steps 610 to 640 according to one embodiment are performed by the ground station 120 described above with reference to FIG. 1. The ground station 120 may be implemented by one or more hardware modules, one or more software modules, or various combinations thereof.

In step 610, the ground station 120 receives order information including content. The order information is information requested by a customer regarding a photographed image, and may include information about content to be displayed on a panel, a photographing time, or a photographing location. For example, the order information may be a request to shoot content in the background of the Earth where a typhoon occurred.

In step 620, the ground station 120 determines whether the satellite is located in a communicationable area. This is because the ground station according to an embodiment has a limited time for communicating with the artificial satellite.

In step 630, the ground station 120 transmits a mission including the content to the satellite. The mission may include content and preference information to be displayed on the panel. The preference information is information generated based on the customer's order information, and may include information about a shooting time or a shooting location. The preference information may be determined based on the order information and flight dynamics of the satellite. For example, when the order information is a request to record content in the background of the Earth where a typhoon has occurred, the ground station may predict the orbit of the artificial satellite based on the order information. Based on the predicted orbit of the satellite, preference information regarding specific time and coordinates can be determined.

In step 640, the ground station 120 receives a captured image in which content is captured in the outer space as a background by an artificial satellite. The captured image may be the captured image described above with reference to FIGS. 2 to 4.

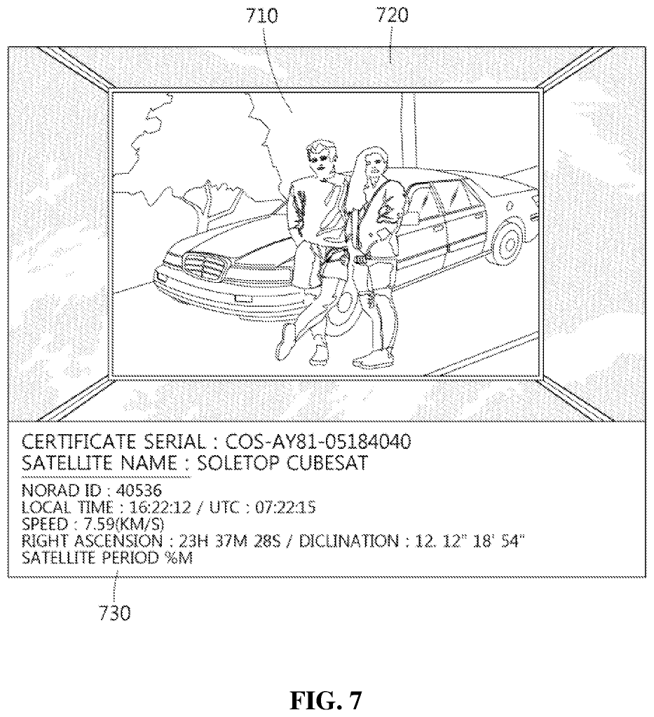

FIG. 7 is a diagram illustrating a photographed image including a certificate according to an exemplary embodiment.

Referring to FIG. 7, the captured image according to an embodiment may further include a certificate 730.

The artificial satellite can acquire information about the shooting environment when shooting using the image sensor and transmit it to the ground station. The information on the photographing environment may include at least one of a serial number of an artificial satellite in which photographing is performed, a photographing time, a position of the artificial satellite during photographing, and a posture of the artificial satellite during photographing. The information on the photographing environment may further include motion information such as acceleration, velocity, and/or angular velocity of the artificial satellite. The ground station may generate the certificate 730 based on the information on the photographing environment. The certificate 730 may be displayed together with the captured image or may be generated separately from the captured image.

The method according to the embodiment may be implemented in the form of program instructions that can be executed through various computer means and recorded in a computer-readable medium. The computer-readable medium may include program instructions, data files, data structures, etc. alone or in combination. The program instructions recorded on the medium may be specially designed and configured for the embodiment, or may be known and available to those skilled in the art of computer software. Examples of the computer-readable recording medium include magnetic media such as hard disks, floppy disks and magnetic tapes, optical media such as CD-ROMs and DVDs, and magnetic such as floppy disks.—includes magneto-optical media, and hardware devices specially configured to store and execute program instructions, such as ROM, RAM, flash memory, and the like. Examples of program instructions include not only machine language codes such as those generated by a compiler, but also high-level language codes that can be executed by a computer using an interpreter or the like. The hardware devices described above may be configured to operate as one or more software modules to perform the operations of the embodiments, and vice versa.

Software may comprise a computer program, code, instructions, or a combination of one or more of these, which configures a processing device to operate as desired or is independently or collectively processed You can command the device. The software and/or data may be any kind of machine, component, physical device, virtual equipment, computer storage medium or device, to be interpreted by or to provide instructions or data to the processing device, or may be permanently or temporarily embody in a transmitted signal wave. The software may be distributed over networked computer systems and stored or executed in a distributed manner. Software and data may be stored in one or more computer-readable recording media.

As described above, although the embodiments have been described with reference to the limited drawings, those skilled in the art may apply various technical modifications and variations based on the above. For example, the described techniques are performed in an order different from the described method, and/or the described components of the system, structure, apparatus, circuit, etc. are combined or combined in a different form than the described method, or other components or substituted or substituted by equivalents may achieve an appropriate result.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. As a satellite for transmitting an image to the at least one ground station, it operates in a space environment, displays the content received from at least one ground station, captures the content with the background in outer space, and captures the content and comprises;
a satellite body for receiving a mission including the content from the at least one ground station,
a display panel for displaying the content received from the at least one ground station,
an image sensor for photographing the content displayed on the display panel with the outer space as a background, and
a direction sensor capable of determining a photographing direction of the image sensor,
wherein the mission further includes a request for shooting at least one of an image, video, or text desired by the customer with information about a shooting time or shooting location generated based on the customer's order information, and a real outer space as a background,
when the shooting direction of the image sensor matches the mission with respect to the direction sensor, the satellite body determines a position between the display panel and the image sensor, and determines a photographing area of the image sensor,
wherein the image sensor is a satellite, characterized in that for shooting the content in real outer space as a background at a shooting time or shooting location included in the mission.

2. The satellite of claim 1,
wherein the satellite body receives the content from another satellite, the satellite.

3. The satellite of claim 1,
wherein the satellite body is a satellite for transmitting information on a photographing environment including at least one of a serial number, a photographing time, and a photographing location of the satellite in which photographing has been performed, to the at least one ground station.

4. The satellite of claim 1,
wherein the content includes at least one of a still image and a moving image, the satellite.

5. The satellite of claim 1,
wherein the content includes at least one of text, a still image, and a moving image, and the captured image includes at least one of a still image and a moving image, satellite.

6. The satellite of claim 1,
wherein the satellite body is a satellite that adjusts the content displayed on the display panel based on the background.
